(19) United States
(12) Patent Application Publication
(10) Pub. No.: US 2026/0362028 A1
(43) Pub. Date: Nov. 12, 2026

(54) EVENT-BASED PIXEL ARRAY WITH DISTRIBUTED CONTROLLER TREE ARCHITECTURE

(71) Applicant: Alphacore, Inc., Tempe, AZ (US)

(72) Inventor: Laurent Blanquart, Westlake Village, CA (US)

(21) Appl. No.: 19/674,885

(22) Filed: May 12, 2026

Related U.S. Application Data
(60) Provisional application No. 63/804,294, filed on May 12, 2025.

(51) Int. Cl. H04N 25/47; G06F 16/22; H04N 25/707; H04N 25/77

(52) U.S. Cl. CPC H04N 25/47; G06F 16/2246; H04N 25/707; H04N 25/77

(57) ABSTRACT

An integrated circuit device includes an array of pixel cells arranged in rows and columns. Each pixel cell includes a pixel-specific photosensor configured to generate an event signal in response to detected incident radiation, and a pixel-specific controller that includes an arbiter having two inputs and one output. The arbiter is configured to resolve contention between request signals received at the two inputs. Subsets of the pixel-specific controllers are operatively coupled in respective hierarchical tree structures. Each pixel-specific controller is configured to generate an address bit based on a position of the pixel-specific controller within a respective hierarchical tree structure. Each hierarchical tree structure is configured to propagate request signals and address information toward a serializer interface while propagating acknowledge signals in a reverse direction through an established path.

### CROSS-REFERENCE TO RELATED APPLICATIONS

This application claim priority U.S. Provisional Patent Application No. 63/804,294, titled “SYSTEMS AND METHODS FOR IMAGE SENSING WITH EVENT-BASED NEUROGRID ARCHITECTURE, filed May 12, 2025, which is hereby incorporated by reference in its entirety.

### FIELD OF INVENTION

The present disclosure relates to event-based sensing architectures, and more particularly to an integrated circuit device including an array of pixel cells.

### BACKGROUND

Event-based sensing architectures represent an approach to image capture that differs from conventional frame-based imaging systems. In frame-based systems, image brightness information is read out from pixels at fixed intervals using row and column scanners, which can produce large amounts of data in high-speed sensors. Event-based vision sensors, by contrast, allow pixels to respond asynchronously to light intensity changes, generating event signals that are communicated through readout circuitry.

Event-based vision sensors may offer advantages such as reduced power consumption, sub-millisecond latency, and sparse output compared to standard frame-based cameras. These characteristics have attracted interest from imaging communities in both academia and industry. In some implementations, event-based sensors utilize Address Event Representation (AER) protocols to enable asynchronous readout, where pixel events are communicated through a shared output bus in the form of address-event representations.

In some event-based readout architectures, when a pixel detects an event, it requests access from row and column arbitration circuits. After receiving acknowledgment, the pixel communicates with column arbitration circuitry to gain access to a shared output bus for transmitting pixel address information. This sequential order of row and column arbitration before actual readout communication can provide an efficient readout mechanism for sparse events while avoiding contention issues on the output bus when multiple pixels generate events simultaneously.

However, event-based sensing architectures may face challenges as pixel counts increase. In some implementations, the number of column and row positions increases linearly while the number of pixels increases quadratically, which can cause peripheral arbitration and routing to increasingly affect scaling behavior. Handshaking communication protocols may involve multiple exchanges of information between the pixel array and a host receiver to communicate a single event. When instantaneous event detection rates exceed maximum readout speeds, simultaneous events may queue for communication, potentially resulting in increased readout latency. This increase in readout latency may be non-deterministic for individual events due to the use of arbitration in determining queueing sequence.

In arbitration-based, event-driven readout systems, when multiple requests arrive in a short time window, one request may win arbitration while other requests are queued until the winning input releases the output bus. As a result, event-handling order may become unpredictable and cause timing variations even between neighboring pixels. Additionally, output-port and pad resources may not scale favorably with dense pixel arrays, and at smaller pixel sizes, providing one output port per column may be impractical for real-estate and power-consumption reasons.

Accordingly, there is a general interest in event-based sensing architectures that can address one or more of these considerations.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, an integrated circuit device is provided. The integrated circuit device includes an array of pixel cells arranged in rows and columns. Each pixel cell includes a pixel-specific photosensor configured to generate an event signal in response to detected incident radiation, and a pixel-specific controller including an arbiter having two inputs and one output. The arbiter is configured to resolve contention between request signals received at the two inputs. Subsets of the pixel-specific controllers are operatively coupled in respective hierarchical tree structures. Each pixel-specific controller is configured to generate an address bit based on a position of the pixel-specific controller within a respective hierarchical tree structure. Each hierarchical tree structure is configured to propagate request signals and address information toward a serializer interface while propagating acknowledge signals in a reverse direction through an established path.

According to other aspects of the present disclosure, the arbiter may include an asynchronous latch.

According to other aspects of the present disclosure, the asynchronous latch may include a Set/Reset latch.

According to other aspects of the present disclosure, the pixel-specific controllers may be operatively coupled in the respective hierarchical tree structures via conductive interconnections coupling the output of an arbiter of one pixel-specific controller to an input of an arbiter of another pixel-specific controller.

According to other aspects of the present disclosure, a first layer of each hierarchical tree structure may include conductive interconnections coupling outputs of arbiters of pixel-specific controllers associated with pairs of adjacent pixel cells to inputs of arbiters of pixel-specific controllers at a second layer. Higher layers of each hierarchical tree structure may include conductive interconnections coupling outputs of arbiters of pixel-specific controllers from a preceding layer to inputs of arbiters of pixel-specific controllers at a subsequent layer.

According to other aspects of the present disclosure, each pixel-specific controller may be further configured to store lower-priority event data when a collision occurs between simultaneous request signals from the two inputs.

According to other aspects of the present disclosure, each hierarchical tree structure may be configured to release the stored lower-priority event data upon receipt of an acknowledge signal.

According to other aspects of the present disclosure, a number of pixel-specific controllers in the array of pixel cells may be equal to a number of pixel cells minus one.

According to other aspects of the present disclosure, each pixel-specific controller may include a universal controller design, and each pixel-specific controller may further include a spare address bit output configurable through routing.

According to other aspects of the present disclosure, each hierarchical tree structure may include a plurality of layers. Pixel-specific controllers at lower layers may generate lower-significance address bits and pixel-specific controllers at higher layers may generate higher-significance address bits.

According to other aspects of the present disclosure, the integrated circuit device may further include a serializer coupled to an output of each hierarchical tree structure. The serializer may be configured to receive event data and address information from a final layer of the hierarchical tree structure.

According to other aspects of the present disclosure, for each pixel cell, the pixel-specific controller may be physically located within the pixel cell adjacent to the pixel-specific photosensor.

According to other aspects of the present disclosure, each pixel cell may include a common pixel cell layout, and the pixel-specific photosensor and the pixel-specific controller may be integrated within the common pixel cell layout.

According to other aspects of the present disclosure, each hierarchical tree structure may couple pixel-specific controllers along a column of the array, along a row of the array, or across a plurality of columns or rows of the array.

According to other aspects of the present disclosure, the arbiter of each pixel-specific controller may include an asynchronous Set/Reset latch. The pixel-specific controllers may be operatively coupled in the respective hierarchical tree structures via conductive interconnections. Each hierarchical tree structure may include a plurality of layers wherein pixel-specific controllers at lower layers generate lower-significance address bits and pixel-specific controllers at higher layers generate higher-significance address bits. Each pixel-specific controller may be configured to store lower-priority event data when a collision occurs between simultaneous request signals from the two inputs and to release the stored lower-priority event data upon receipt of an acknowledge signal. For each pixel cell, the pixel-specific controller may be physically located within the pixel cell adjacent to the pixel-specific photosensor.

According to other aspects of the present disclosure, the arbiter of each pixel-specific controller may include an asynchronous Set/Reset latch. The pixel-specific controllers may be operatively coupled in the respective hierarchical tree structures via conductive interconnections coupling the output of an arbiter of one pixel-specific controller to an input of an arbiter of another pixel-specific controller. A first layer of each hierarchical tree structure may include conductive interconnections coupling outputs of arbiters of pixel-specific controllers associated with pairs of adjacent pixel cells to inputs of arbiters of pixel-specific controllers at a second layer. Higher layers of each hierarchical tree structure may include conductive interconnections coupling outputs of arbiters of pixel-specific controllers from a preceding layer to inputs of arbiters of pixel-specific controllers at a subsequent layer.

According to another aspect of the present disclosure, a method of operating an integrated circuit device including an array of pixel cells is provided. The method includes detecting, by a pixel-specific photosensor of a pixel cell, incident radiation and generating an event signal in response thereto. The method includes receiving, at an arbiter of a pixel-specific controller associated with the pixel cell, a request signal corresponding to the event signal at one of two inputs of the arbiter. The method includes resolving, by the arbiter, contention between request signals received at the two inputs. The method includes generating, by the pixel-specific controller, an address bit based on a position of the pixel-specific controller within a hierarchical tree structure in which subsets of pixel-specific controllers are operatively coupled. The method includes propagating, through the hierarchical tree structure, request signals and address information toward a serializer interface while propagating acknowledge signals in a reverse direction through an established path.

According to other aspects of the present disclosure, the method may further include storing, by the pixel-specific controller, lower-priority event data when a collision occurs between simultaneous request signals at the two inputs of the arbiter, and releasing the stored lower-priority event data upon receipt of an acknowledge signal.

According to other aspects of the present disclosure, generating the address bit may include generating a lower-significance address bit by pixel-specific controllers at lower layers of the hierarchical tree structure and generating a higher-significance address bit by pixel-specific controllers at higher layers of the hierarchical tree structure.

According to other aspects of the present disclosure, the method may further include receiving, at a serializer coupled to an output of the hierarchical tree structure, event data and address information from a final layer of the hierarchical tree structure, and serializing the event data and address information for output.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of an event-based sensing architecture with peripheral circuitry, according to aspects of the present disclosure.

FIG. 2A illustrates a block diagram of a pixel cell architecture for an event-based sensing system, according to aspects of the present disclosure.

FIG. 2B illustrates a circuit diagram of a four-transistor pixel configuration, according to aspects of the present disclosure.

FIG. 2C illustrates a block diagram of a controller for use within a distributed arbiter architecture, according to aspects of the present disclosure.

FIG. 3 illustrates a hierarchical tree structure for a distributed controller architecture within a pixel array, according to aspects of the present disclosure.

FIG. 4 illustrates operational coupling between photosensors and controllers in a hierarchical tree structure, according to aspects of the present disclosure.

FIG. 5 illustrates four sequential stages of event collision and priority handling within a distributed controller tree architecture, according to aspects of the present disclosure.

FIG. 6 illustrates a hierarchical tree structure with address bit significance at each layer, according to aspects of the present disclosure.

FIG. 7 depicts a table showing implementation relationships for a distributed controller architecture across varying numbers of bits, according to aspects of the present disclosure.

FIG. 8 illustrates a controller circuit block diagram with a spare address bit output, according to aspects of the present disclosure.

FIG. 9A illustrates a floorplan diagram of a modular slice arrangement for a single-port configuration, according to aspects of the present disclosure.

FIG. 9B illustrates a floorplan diagram of a modular slice arrangement for a double-port configuration, according to aspects of the present disclosure.

FIG. 10 illustrates a system diagram of a distributed controller arrangement for an event-based pixel array architecture, according to aspects of the present disclosure.

FIG. 11A illustrates a data transfer diagram for a distributed controller architecture, according to aspects of the present disclosure.

FIG. 11B illustrates an address transfer diagram for a distributed controller architecture, according to aspects of the present disclosure.

FIG. 12 illustrates a flowchart of a method of operating an integrated circuit device comprising an array of pixel cells, according to aspects of the present disclosure.

Throughout the description, similar reference numbers may be used to identify similar elements.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Conventional event-based sensing architectures require extensive handshaking between side circuitry and pixels, together with substantial row and column circuitry. As pixel counts increase, the number of column and row positions increases linearly while the number of pixels increases quadratically, so peripheral arbitration and routing increasingly dominate scaling behavior. The disclosed event-based neurogrid architecture addresses this problem by replacing a complex single peripheral arbiter in an integrated circuit device with a swarm of arbiter/controller elements distributed in the pixel array. The controller grid is implemented using neuromorphic connections among identical pixel controllers so that decisions are made locally and then moved asynchronously to the pixel-array periphery. In representative arrangements, the tree is bidirectional: request, address, and up/down signaling propagate downward through the tree toward the serializer side, while acknowledge propagates upward in the reverse direction. Each controller includes an arbiter, such as an asynchronous Set/Reset latch, that arbitrates between two inputs and generates one bit of address information, with bit significance related to the controller layer position. The event address is therefore naturally encoded by the distributed controller grid and becomes available at the array edge without a separate centralized address encoder or address-assembly block.

The architecture is largely agnostic to the number of pixels because arbitration is distributed across repeated local controllers rather than concentrated in a single peripheral arbiter. The local controller design is very simple, in representative embodiments, the controller is a 1-bit element built around an asynchronous Set/Reset latch arbiter, and no complex side circuitry is needed other than a serializer. The hierarchical tree structure can handle all pixels simultaneously in the sense that collisions and temporary storage are managed within the distributed controller network. When a collision occurs, priority is handled only by the controller arbiter at the contention point and the lower-priority event data naturally stays in that controller, while the tree switches are naturally set up such that the serializer can send back acknowledge along the already established path to reset the selected event. This enables lower-priority events to surface faster after acknowledgment, reducing effective dead time between successive events.

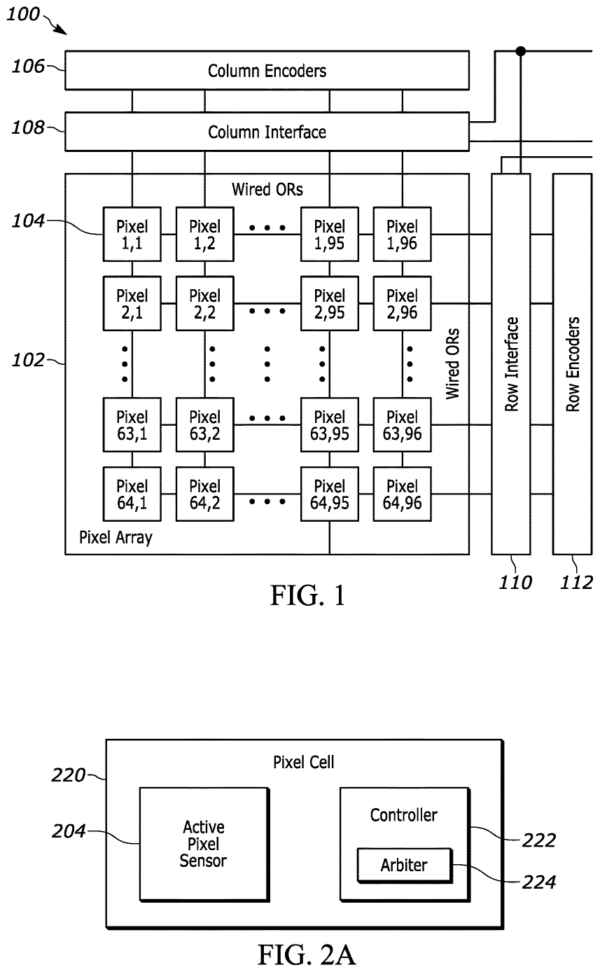

FIG. 1 illustrates a block diagram of an event-based sensing architecture 100, which may be implemented as an integrated circuit device, showing a pixel array 102 with associated peripheral circuitry. The pixel array includes an array of pixels 104 arranged in rows and columns. In the example depicted in FIG. 1, the pixel matrix includes a 64 row by 96 column configuration, though other configurations may be used.

The pixel array 1022 includes pixels 104 positioned at various locations throughout the array. For example, pixel 1,1 may be positioned at an upper left corner of the pixel matrix, with pixel 1,2 adjacent to pixel 1,1 in a first row. Additional pixels such as pixel 1,95 and pixel 1,96 may be positioned toward a right side of the first row. A second row may include pixel 2,1, pixel 2,2, pixel 2,95, and pixel 2,96 arranged in corresponding column positions. The pixel array may continue through intermediate rows to row 63, which may include pixel 63,1, pixel 63,2, pixel 63,95, and pixel 63,96. A final row may include pixel 64,1, pixel 64,2, pixel 64,95, and pixel 64,96 positioned at a bottom of the pixel matrix.

In the conventional architecture depicted in FIG. 1, peripheral circuitry is positioned outside the pixel array 102. Column encoders 106 are positioned above a column interface 108. The column interface connects to the pixel array through wired OR connections that span across columns of the array. The wired OR connections provide a column-wise signal aggregation mechanism for communicating event signals from pixels to the column interface.

On a right side of the pixel array 102, a row interface 110 connects to rows of pixels through wired OR connections that span horizontally across each row. Row encoders 112 are positioned adjacent to the row interface and provide row address encoding functionality.

In the conventional architecture, when a pixel 104 detects an event, the pixel may request access from the row and column arbitration circuits positioned at the periphery of the pixel matrix 102. The row encoders 112 and column encoders 106 perform address encoding to identify which pixel generated the event. The row interface 110 and column interface 108 facilitate communication between the pixel matrix and the peripheral encoding circuitry.

The conventional event-based sensing architecture 100 depicted in FIG. 1 positions arbitration circuitry and address encoding circuitry outside the pixel matrix 102 at the periphery. This peripheral placement may involve handshaking communication between the peripheral circuitry and the pixels 104 within the pixel matrix. As pixel counts increase, the number of column and row positions increases linearly while the number of pixels increases quadratically. This relationship may cause peripheral arbitration and routing to increasingly affect scaling behavior in larger pixel arrays.

The wired OR connections in the conventional architecture aggregate event signals from multiple pixels along each row and column. When multiple pixels generate events simultaneously, the peripheral arbitration circuitry resolves contention to determine which event gains access to a shared output bus. This arbitration process may involve multiple exchanges of information between the pixel array and the peripheral circuitry to communicate a single event. In some cases, when instantaneous event detection rates exceed maximum readout speeds of the peripheral circuitry, simultaneous events may queue for communication. The queueing sequence may be determined by the peripheral arbitration circuitry, and readout latency for individual events may vary based on the arbitration outcome. Event-handling order may become unpredictable when multiple requests arrive within a short time window, as one request may win arbitration while other requests are queued until a winning input releases the output bus.

The following disclosure involves an integrated circuit device with a distributed controller architecture that addresses the scaling challenges of conventional event-based sensing architectures. Rather than positioning arbitration circuitry at the periphery of the pixel matrix, the disclosed architecture integrates a pixel-specific controller with each pixel, enabling distributed arbitration through a hierarchical tree structure that naturally encodes event addresses as signals propagate toward a serializer interface.

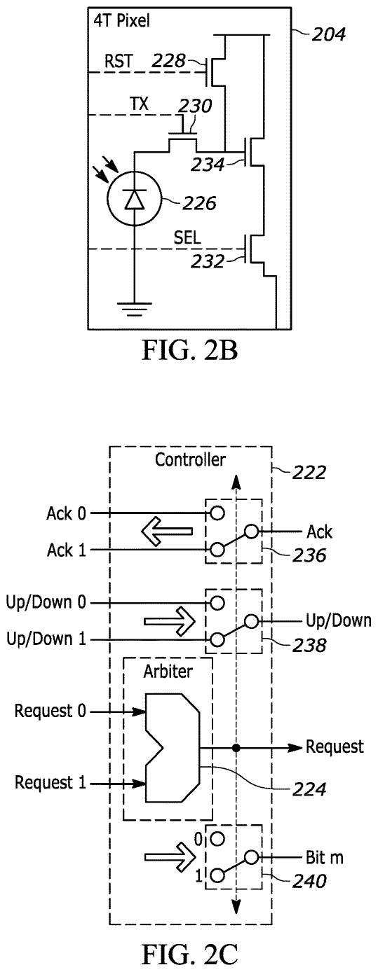

FIG. 2A illustrates a block diagram of a pixel cell 220 for an event-based sensing system that includes a photosensor 204 and a controller 222. In an example, an integrated circuit device may include an array of pixel cells arranged in rows and columns as a pixel array, similar to the pixel array described with reference to FIG. 1, in which each pixel cell includes a pixel-specific photosensor (e.g., a pixel) and a pixel-specific controller.

In the example of FIG. 2A, the pixel-specific photosensor 204, which may be implemented as an active pixel sensor, is configured to generate an event signal in response to detected incident radiation. In operation, the pixel-specific photosensor detects incident radiation and generates an event signal in response thereto. The pixel-specific photosensor provides sensing functionality for the pixel cell and responds to changes in the intensity of electromagnetic energy at the pixel cell location.

In the example of FIG. 2A, the pixel-specific controller 222 is physically located adjacent to the pixel-specific photosensor 204 within the pixel cell 220. The pixel-specific controller includes an arbiter 224 configured to resolve contention between request signals. As is described below, the arbiter facilitates asynchronous event arbitration within a distributed controller tree architecture.

For each pixel cell 220, the pixel-specific controller 222 is physically located within the pixel cell physically close to the pixel-specific photosensor 204. This physical closeness integrates both sensing and control functionality within a single pixel cell layout. Each pixel cell in a pixel array may have an identical pixel cell layout. The identical pixel cell layout enables each pixel cell to include both the photosensitive element for event detection and local arbitration circuitry for distributed event processing.

The pixel-specific controller 222 with the embedded arbiter 224 allows for local decision-making and asynchronous signal propagation toward a pixel array periphery without requiring complex peripheral arbitration circuitry. In some arrangements, the architecture uses one controller per pixel with identical local layout. A universal pixel layout may include a log amplifier, comparators, latches, and the pixel-specific controller. Although the local controller may be common across pixel cells, the overall behavior of the distributed controller network may be defined by wiring connections between pixel-specific controllers.

The pixel cell 220 described with reference to FIG. 2A supports a distributed controller grid implementation where pixel-specific controllers are operatively coupled in hierarchical tree structures. The integration of the pixel-specific photosensor 204 and the pixel-specific controller 222 within each pixel cell enables arbitration to be distributed across repeated local controller cells rather than concentrated in a single peripheral arbiter. As pixel arrays grow, the structure may scale by replication of small in-array elements instead of requiring a correspondingly complex edge-control block.

FIG. 2B illustrates a circuit diagram of a four-transistor (4T) pixel configuration that may be used as one example of the pixel-specific photosensor 204 in an event-based sensing architecture. The 4T pixel configuration represents one implementation of a photosensor that interfaces with the distributed controller elements of the neurogrid architecture.

The 4T pixel configuration includes a photodiode 226 configured to convert incident light into electrical signals. The photodiode is depicted with arrows indicating light input and is connected to ground at a lower terminal of the photodiode. The photodiode serves as the photosensitive component that generates charge in response to incident radiation. The 4T pixel configuration includes four transistors. A first transistor 228 functions as a reset transistor and is connected to a reset line labeled RST. The reset transistor connects to a supply rail. The reset transistor may be used to reset a floating diffusion node to a reference voltage level prior to charge transfer. A second transistor 230 functions as a transfer transistor and is connected to a transfer line labeled TX. The transfer transistor is positioned between an output of the photodiode element and the floating diffusion node. The transfer transistor controls the transfer of accumulated charge from the photodiode element to the floating diffusion node. A third transistor 232 functions as a select transistor and is connected to a select line labeled SEL. The select transistor controls the connection of a pixel output to a column readout line. The select transistor enables selective readout of the pixel cell when the select line is activated. A fourth transistor 234 functions as a source follower transistor and provides buffering between the floating diffusion node and an output path controlled by the select transistor. A gate of the source follower transistor is connected to the floating diffusion node. The source follower transistor converts the voltage at the floating diffusion node to a current signal for readout through the select transistor. In operation, incident light generates charge at the photodiode. The transfer transistor transfers the accumulated charge to the floating diffusion node when the transfer line is activated. The source follower transistor buffers the voltage at the floating diffusion node, and the select transistor connects the buffered signal to the column readout line when the select line is activated. The reset transistor resets the floating diffusion node to prepare for a subsequent integration period.

The 4T pixel configuration interfaces with a corresponding controller of the neurogrid architecture through connections extending from the pixel circuit. The 4T pixel configuration provides event detection and signal generation that feeds into the asynchronous tree structure for arbitration and address formation as described in the event-based neurogrid architecture.

The 4T pixel 204 depicted in FIG. 2B represents one example of a photosensor that may be included in a pixel cell. Other photosensor configurations may be used in alternative implementations. The pixel-specific photosensor described with reference to FIG. 2A may be implemented using the 4T pixel configuration or using other photosensor architectures suitable for event-based sensing applications. The pixel-specific photosensor may be configured to detect electromagnetic radiation across a range of wavelengths and frequencies. In some implementations, the pixel-specific photosensor may be sensitive to visible light wavelengths in a range from approximately 380 nanometers to approximately 700 nanometers. In other implementations, the pixel-specific photosensor may be configured to detect near-infrared radiation in a range from approximately 700 nanometers to approximately 1400 nanometers, short-wave infrared radiation in a range from approximately 1400 nanometers to approximately 3000 nanometers, mid-wave infrared radiation in a range from approximately 3000 nanometers to approximately 8000 nanometers, or long-wave infrared radiation in a range from approximately 8000 nanometers to approximately 15000 nanometers. The pixel-specific photosensor may also be configured to detect ultraviolet radiation at wavelengths shorter than approximately 380 nanometers. The photodiode element or other photosensitive component of the pixel-specific photosensor may be fabricated using materials selected based on a target wavelength range, such as silicon for visible and near-infrared detection, indium gallium arsenide for short-wave infrared detection, or mercury cadmium telluride for mid-wave and long-wave infrared detection. The distributed controller architecture described herein may be implemented with pixel-specific photosensors configured for any of these wavelength ranges or combinations thereof.

FIG. 2C is an example of the controller 222 for use within a distributed arbiter architecture of an event-based sensing system. As described with reference to FIG. 2A, each pixel cell includes a pixel-specific controller comprising an arbiter. FIG. 2C depicts an example of the internal structure and signal routing of the pixel-specific controller in greater detail.

The pixel-specific controller 222 includes the arbiter 224 having two inputs and one output. The two inputs are designated as Request 0 and Request 1. Request 0 may be received from a photosensor of a first pixel cell, and Request 1 may be received from a photosensor of a second pixel cell. In some arrangements, at a first layer of a hierarchical tree structure, the arbiter may receive request inputs from two adjacent pixels. At a higher layer, the arbiter may receive request inputs from two pixel-specific controllers of a previous layer.

The arbiter 224 is configured to resolve contention between request signals received at the two inputs. When a request signal arrives at one of the two inputs, the arbiter processes the request signal and generates a corresponding output. When request signals arrive simultaneously at both inputs, the arbiter resolves contention between the request signals. In some arrangements, the arbiter may resolve contention on a first-come-first-served basis. When request signals arrive simultaneously at both inputs, the arbiter may resolve contention through a hardware-based priority determination mechanism. In one arrangement, the arbiter may resolve contention on a first-come-first-served basis, where the request signal that arrives at the arbiter input marginally earlier than the other request signal is granted priority. The timing difference between the two request signals may be on the order of picoseconds or nanoseconds, and the arbiter hardware is configured to detect and respond to such timing differences. In a hardware implementation, the arbiter may comprise cross-coupled logic gates or transistor pairs that form a bistable element. When a first request signal arrives at one input before a second request signal arrives at the other input, the bistable element transitions to a stable state corresponding to the first request signal. The cross-coupled configuration causes the bistable element to latch into the state associated with the winning request signal, preventing the later-arriving request signal from changing the arbiter output until the arbiter is reset. In an example, if both request signals arrive within an extremely narrow time window such that the bistable element enters a metastable condition, the arbiter hardware eventually resolves to one of the two stable states based on circuit noise, transistor mismatch, or other physical asymmetries in the arbiter circuitry. The metastable resolution time is typically short relative to event processing timescales, allowing the arbiter to provide a deterministic output even when request signals arrive nearly simultaneously.

In an example, the arbiter 224 may comprise an asynchronous latch. In some arrangements, the asynchronous latch may comprise a Set/Reset latch in which the Set/Reset latch provides an asynchronous arbitration mechanism that determines which of the two request inputs gains priority when contention occurs. The asynchronous nature of the Set/Reset latch allows the arbiter to operate without requiring a clock signal, enabling asynchronous event arbitration within the distributed controller tree architecture.

In the example of FIG. 2C, the pixel-specific controller 222 includes acknowledgment routing through switching elements. Two acknowledgment inputs, labeled Ack 0 and Ack 1, correspond to the first and second pixel cells and are routed through a switching element 236 within the pixel-specific controller. The acknowledgment paths are selectively connected to a single Ack output on a right side of the pixel-specific controller based on a state established by the arbiter. When the arbiter resolves contention between request signals, the arbiter sets the switching element to route the acknowledgment signal to the appropriate source through the established path as indicated by the corresponding arrow.

The pixel-specific controller 222 also includes Up/Down signal paths for propagating event direction information. Two Up/Down signal inputs, labeled Up/Down 0 and Up/Down 1, correspond to the first and second pixel cells and pass through a switching element 238. The two Up/Down paths are selectively routed to a single Up/Down output based on the arbiter state. The Up/Down signal path allows event direction information to propagate through the hierarchical tree structure toward a serializer interface as indicated by the corresponding arrow.

As illustrated in FIG. 2C, the output of the arbiter 224 is a Request that propagates to a subsequent controller layer or to a serializer. In addition, the state of the arbiter controls a bit selection mechanism 240 of the pixel-specific controller. The bit selection mechanism includes two selectable positions labeled 0 and 1 that determine a value of an output designated as Bit m. The Bit m output represents one bit of address information, with bit significance corresponding to a layer position of the pixel-specific controller within a hierarchical tree structure. As described in more detail below, pixel-specific controllers at lower layers of the hierarchical tree structure may generate lower-significance address bits, and pixel-specific controllers at higher layers may generate higher-significance address bits.

The pixel-specific controller 222 described with reference to FIG. 2C enables bidirectional signal flow within a hierarchical tree structure. Request signals, address information, and Up/Down signals propagate in one direction toward the serializer, while acknowledge signals return through the established path in a reverse direction. When a collision occurs between simultaneous request signals at the two inputs of the arbiter 224, the arbiter resolves priority and lower-priority event data remains stored within the pixel-specific controller for subsequent release after acknowledgment. The pixel-specific controller design allows the hierarchical tree structure to handle multiple simultaneous events through distributed collision handling and local storage within the pixel-specific controllers.

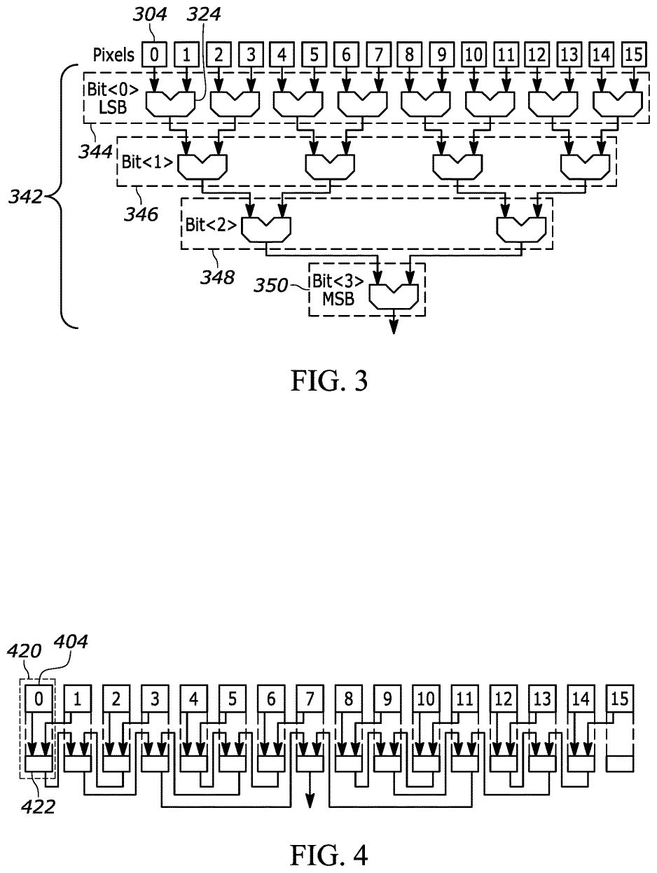

FIG. 3 illustrates one example of a hierarchical tree structure 342 for a distributed controller architecture within a pixel array that includes pixels 304 and controllers, which are graphically represented in FIG. 3 as arbiters 324, although it should be understood that each arbiter represents a controller, such as the controller described with reference to FIGS. 2A and 2C. FIG. 3 depicts a logical representation of the hierarchical tree structure and does not represent the physical arrangement of the pixel-specific controllers and the pixel cells within the integrated circuit device. In the example of FIG. 3, each pixel-specific photosensor and each pixel-specific controller is part of a pixel cell as described with reference to FIGS. 2A-2C, where each pixel cell is fabricated as a unit within a pixel array.

In the example depicted in FIG. 3, sixteen pixels, labeled Pixels 0 through 15, are positioned in a row. Below the row of pixels, multiple layers of pixel-specific controllers are arranged in a binary hierarchical tree configuration. Subsets of the pixel-specific controllers are operatively coupled in a hierarchical tree structure via conductive interconnections coupling the output of an arbiter of one pixel-specific controller to an input of an arbiter of another pixel-specific controller.

The hierarchical tree structure 342 that is logically depicted in FIG. 3 comprises a plurality of layers. A first layer 344, designated as Bit<0> and identified as the LSB (Least Significant Bit), includes eight pixel-specific controllers (represented as arbiters 324). The first layer of the hierarchical tree structure comprises conductive interconnections coupling outputs of arbiters of pixel-specific controllers associated with pairs of adjacent pixel cells to inputs of arbiters of pixel-specific controllers at a second layer 346. In the example depicted in FIG. 3, each pixel-specific controller in the first layer receives inputs from two adjacent pixel cells. A first pixel-specific controller in the first layer connects to Pixels 0 and 1, while subsequent pixel-specific controllers in the first layer are operatively coupled to successive pairs of pixel cells across the array. In particular, pixels 2 and 3 are operatively coupled to a second pixel-specific controller, pixels 4 and 5 are operatively coupled to a third pixel-specific controller, pixels 6 and 7 are operatively coupled to a fourth pixel-specific controller, pixels 8 and 9 are operatively coupled to a fifth pixel-specific controller, pixels 10 and 11 are operatively coupled to a sixth pixel-specific controller, pixels 12 and 13 are operatively coupled to a seventh pixel-specific controller, and pixels 14 and 15 are operatively coupled to an eighth pixel-specific controller.

Higher layers of the hierarchical tree structure comprise conductive interconnections coupling outputs of arbiters of pixel-specific controllers from a preceding layer to inputs of arbiters of pixel-specific controllers at a subsequent layer. The second layer 346, designated as Bit<1>, includes four pixel-specific controllers. Each pixel-specific controller in the second layer receives inputs from two pixel-specific controllers of the Bit<0> layer, thereby aggregating information from four pixel cells per pixel-specific controller.

The third layer 348, designated as Bit<2>, includes two pixel-specific controllers (represented as an arbiter 324). Each pixel-specific controller in the third layer receives inputs from two pixel-specific controllers of the Bit<1> layer 346, aggregating information from eight pixel cells per pixel-specific controller.

The fourth layer 350, designated as Bit<3> and identified as the MSB (Most Significant Bit), includes a single pixel-specific controller (represented as an arbiter 324) operatively coupled at a highest position in the hierarchical tree structure 342. The pixel-specific controller in the fourth layer receives inputs from the two pixel-specific controllers of the Bit<2> layer and aggregates information from all sixteen pixel cells.

Each pixel-specific controller is configured to generate an address bit based on a position of the pixel-specific controller within the hierarchical tree structure 342. Pixel-specific controllers at lower layers of the hierarchical tree structure generate lower-significance address bits, and pixel-specific controllers at higher layers generate higher-significance address bits. In the example depicted in FIG. 3, pixel-specific controllers in the Bit<0> layer 344 generate the least significant address bit, pixel-specific controllers in the Bit<1> layer 346 generate a next address bit, pixel-specific controllers in the Bit<2> layer 348 generate a subsequent address bit, and the pixel-specific controller in the Bit<3> layer 350 generates the most significant address bit.

The solid line arrows connecting the various layers 344, 346, 348, and 350 of the hierarchical tree structure 342 in FIG. 3 represent signal paths between pixel-specific controllers. The hierarchical tree structure illustrates how request signals, address information, and event signaling propagate through successive layers toward a serializer interface. Although not illustrated in FIG. 3, acknowledge signals propagate in a reverse direction through an established path. Each pixel-specific controller generates one bit of address information corresponding to a layer position of the pixel-specific controller, with lower layers generating lower-significance bits and upper layers generating higher-significance bits. The hierarchical arrangement enables distributed arbitration and address formation within a pixel array.

In an example, the hierarchical tree structure 342 described with reference to FIG. 3 is implemented through fabricated conductive paths within an integrated circuit device. For example, the conductive interconnections that couple inputs of arbiters of pixel-specific controllers to pixels and outputs of arbiters of pixel-specific controllers to inputs of arbiters of other pixel-specific controllers are formed as metal traces or other conductive elements during fabrication of the integrated circuit device. These conductive paths establish the signal routing that enables request signals, address information, and Up/Down signals to propagate through successive layers of the hierarchical tree structure toward the serializer interface, while also providing the return paths through which acknowledge signals propagate in the reverse direction. The physical implementation of the hierarchical tree structure through fabricated conductive paths is further described with reference to FIG. 4.

FIG. 4 illustrates operational coupling between pixel-specific photosensors 404 (e.g., pixels) and pixel-specific controllers 422 of pixel cells 420 to implement a hierarchical tree structure for a distributed controller architecture within a pixel array. FIG. 4 depicts a physical arrangement in which each pixel cell includes a pixel-specific photosensor and a pixel-specific controller that are fabricated as a single unit within the pixel cell. The pixel-specific photosensor and the pixel-specific controller of each pixel cell are physically co-located and connected through conductive paths that conduct electrical signals from the pixel-specific photosensor to the arbiter of the pixel-specific controller. The hierarchical tree structure formed through the physical connections described with reference to FIG. 4 is the same as the hierarchical tree structure 342 described with reference to FIG. 3.

In the example depicted in FIG. 4, sixteen pixels 404 numbered zero through fifteen are arranged horizontally. Below each pixel, a corresponding pixel-specific controller 422 is shown, with the pixel-specific controllers interconnected in a binary tree configuration through conductive interconnections (which are represented by solid line arrows). The conductive interconnections form signal paths that couple outputs of arbiters of pixel-specific controllers to inputs of arbiters of other pixel-specific controllers, thereby establishing the hierarchical tree structure.

In an example, each hierarchical tree structure is configured to propagate request signals and address information toward a serializer interface while propagating acknowledge signals in a reverse direction. As illustrated in FIG. 4, request signals generated by pixel-specific photosensors propagate through successive layers of the hierarchical tree structure toward a trunk connection at the center of the diagram, where event data and address information may be delivered to a serializer. Acknowledge signals return through the hierarchical tree structure in the reverse direction, from the serializer interface back through the hierarchical tree structure toward the originating pixel cell.

The hierarchical tree structure may couple pixel-specific controllers along a column of a pixel array, along a row of a pixel array, or across a plurality of columns or rows of a pixel array. In the example depicted in FIG. 4, the hierarchical tree structure couples pixel-specific controllers across a row of sixteen pixels. In other arrangements, the hierarchical tree structure may couple pixel-specific controllers along a single column, or the hierarchical tree structure may span multiple columns or multiple rows of a pixel array.

The pixel-specific controllers 422 in FIG. 4 are organized into multiple layers within the hierarchical tree structure. Each pixel-specific controller physically corresponds to a specific pixel cell and is assigned to a specific layer based on the position of the pixel-specific controller within the hierarchical tree structure. The pixel-specific controllers generate an address bit based on a position of the respective pixel-specific controller within the hierarchical tree structure.

In the example of FIG. 4, the first layer of the hierarchical tree structure includes controllers that correspond to pixel cells at even-numbered pixel positions. In particular, the first layer includes the controller corresponding to pixel 0, the controller corresponding to pixel 2, the controller corresponding to pixel 4, the controller corresponding to pixel 6, the controller corresponding to pixel 8, the controller corresponding to pixel 10, the controller corresponding to pixel 12, and the controller corresponding to pixel 14. Each controller in the first layer receives a request input from the pixel-specific photosensor of the corresponding pixel cell and a request input from the pixel-specific photosensor of an adjacent pixel cell. For example, the controller corresponding to pixel 0 receives request inputs from pixel 0 and pixel 1, the controller corresponding to pixel 2 receives request inputs from pixel 2 and pixel 3, and so forth across the array.

The second layer of the hierarchical tree structure includes controllers that correspond to pixel cells at positions 1, 5, 9, and 13. Each controller in the second layer receives request inputs from two controllers of the first layer. The controller corresponding to pixel 1 receives inputs from the controller corresponding to pixel 0 and the controller corresponding to pixel 2. The controller corresponding to pixel 5 receives inputs from the controller corresponding to pixel 4 and the controller corresponding to pixel 6. The controller corresponding to pixel 9 receives inputs from the controller corresponding to pixel 8 and the controller corresponding to pixel 10. The controller corresponding to pixel 13 receive inputs from the controller corresponding to pixel 12 and from the controller corresponding to pixel 14.

The third layer of the hierarchical tree structure includes the controller corresponding to pixel 3 and the controller corresponding to pixel 11. The controller corresponding to pixel 3 receives inputs from the controller corresponding to pixel 1 and the controller corresponding to pixel 5. The controller corresponding to pixel 11 receives inputs from the controller corresponding to pixel 9 and the controller corresponding to pixel 13.

The fourth layer of the hierarchical tree structure includes the controller corresponding to pixel 7. The controller corresponding to pixel 7 receives inputs from the controller corresponding to pixel 3 and the controller corresponding to pixel 11 and aggregates information from multiple pixels toward the serializer interface. In the arrangement depicted in FIG. 4, the controller corresponding to pixel 15 is not used within the hierarchical tree structure. The controller corresponding to pixel 15 may remain inactive or may be configured for other purposes in alternative arrangements.

The layer assignments in FIG. 4 correspond to the logical layer designations described with reference to FIG. 3. The controllers in the first layer of FIG. 4 correspond to the pixel-specific controllers in the Bit<0> layer of FIG. 3, which generate the least significant address bit. The controllers in the second layer of FIG. 4 correspond to the pixel-specific controllers in the Bit<1> layer of FIG. 3, which generate a next address bit. The controller in the third layer of FIG. 4 corresponds to pixel-specific controllers in higher layers of FIG. 3, which generate higher-significance address bits.

The wiring pattern shown in FIG. 4 demonstrates how the architecture scales with the number of pixel cells while maintaining a consistent local controller design throughout the pixel array. The conductive interconnections between pixel-specific controllers form the signal paths through which request signals, address information, and Up/Down signals propagate toward a serializer interface. In an example, the same conductive interconnections provide the established path through which acknowledge signals propagate in the reverse direction from the serializer interface back toward the originating pixel cell. The bidirectional nature of the hierarchical tree structure enables asynchronous event arbitration and address formation within the pixel array.

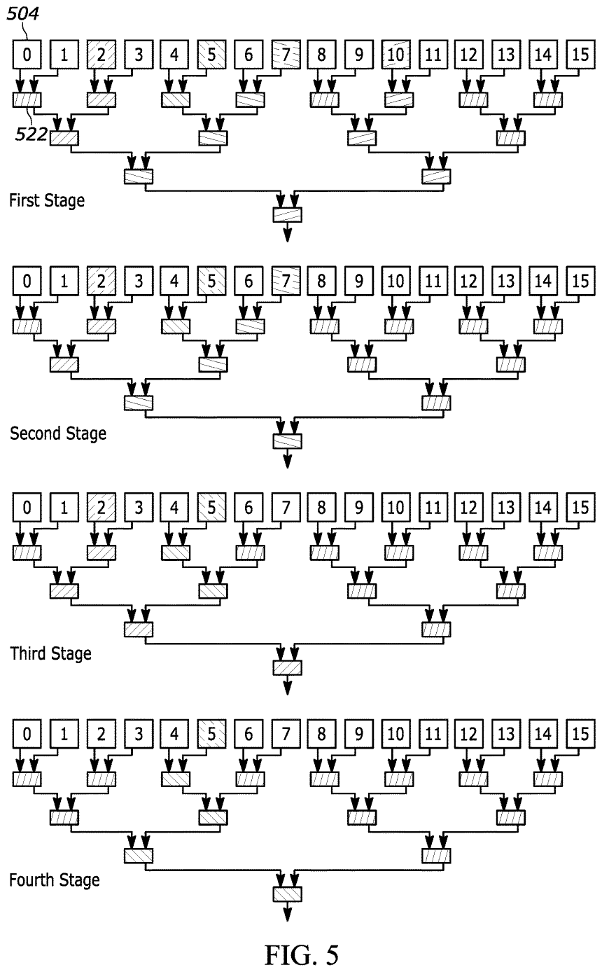

FIG. 5 illustrates four sequential stages of event collision and priority handling within the hierarchical tree architecture, which is similar to the hierarchical tree structures described with reference to FIGS. 3 and 4. FIG. 5 depicts the same row of sixteen pixel cells, labeled Pixels 0 through 15, with a hierarchical tree structure of pixel-specific controllers extending from the row of pixels. The pixel-specific controllers are arranged in successive layers, with each layer performing arbitration between pairs of inputs from a layer above.

In an example, each pixel-specific controller is configured to store lower-priority event data when a collision occurs between simultaneous request signals from the two inputs of an arbiter. When multiple pixel cells generate event signals simultaneously, the arbiters at contention points within the hierarchical tree structure resolve priority between the request signals. The arbiter at each contention point determines which request signal wins arbitration, and the lower-priority event data remains stored within the pixel-specific controller at the contention point rather than being discarded or sent to a separate buffering structure. In an example, the hierarchical tree structure is configured to release the stored lower-priority event data upon receipt of an acknowledge signal. When a prioritized event reaches the serializer interface and the serializer issues an acknowledge signal, the acknowledge signal propagates in the reverse direction through the established path within the hierarchical tree structure. The acknowledge signal resets the pixel-specific controller that handled the prioritized event, which allows the stored lower-priority event data to surface and propagate toward the serializer interface.

In the first stage depicted in FIG. 5, four pixel cells generate event signals simultaneously at Pixel 2, Pixel 5, Pixel 7, and Pixel 10. The event signals propagate through the hierarchical tree structure, and collisions occur at multiple contention points within the tree. At each contention point, the arbiter of the pixel-specific controller resolves priority between the colliding request signals. In the first stage, the event at Pixel 10 wins arbitration through the successive layers of the hierarchical tree structure and reaches the serializer interface. The events at Pixel 2, Pixel 5, and Pixel 7 remain stored within respective pixel-specific controllers at the contention points where the events lost arbitration.

In the second stage depicted in FIG. 5, the serializer issues an acknowledge signal after receiving the event data and address information from Pixel 10. The acknowledge signal propagates in the reverse direction through the established path, resetting the pixel-specific controllers along the path. The release of the stored lower-priority event data allows the remaining events to compete for access to the serializer interface. In the second stage, the event at Pixel 7 wins arbitration and reaches the serializer interface. The events at Pixel 2 and Pixel 5 remain stored within respective pixel-specific controllers.

In the third stage depicted in FIG. 5, the serializer issues an acknowledge signal after receiving the event data and address information from Pixel 7. The acknowledge signal propagates through the established path and resets the pixel-specific controllers along the path. The stored lower-priority event data at Pixel 2 and Pixel 5 becomes available for arbitration. In the third stage, the event at Pixel 2 wins arbitration and reaches the serializer interface. The event at Pixel 5 remains stored within a pixel-specific controller.

In the fourth stage depicted in FIG. 5, the serializer issues an acknowledge signal after receiving the event data and address information from Pixel 2. The acknowledge signal propagates through the established path and resets the pixel-specific controllers along the path. In the fourth stage, the event at Pixel 5 wins arbitration and reaches the serializer interface.

Over the four stages depicted in FIG. 5, the events at Pixel 2, Pixel 5, Pixel 7, and Pixel 10 all reach the serializer interface. The hierarchical tree structure handles the four simultaneous events through distributed collision handling and local storage within the pixel-specific controllers. The pixel-specific controllers store lower-priority event data when collisions occur between simultaneous request signals, and the hierarchical tree structure releases the stored lower-priority event data upon receipt of acknowledge signals. The distributed collision handling allows lower-priority events to surface after acknowledgment, which may reduce effective dead time between successive events compared to architectures that discard lower-priority events during arbitration.

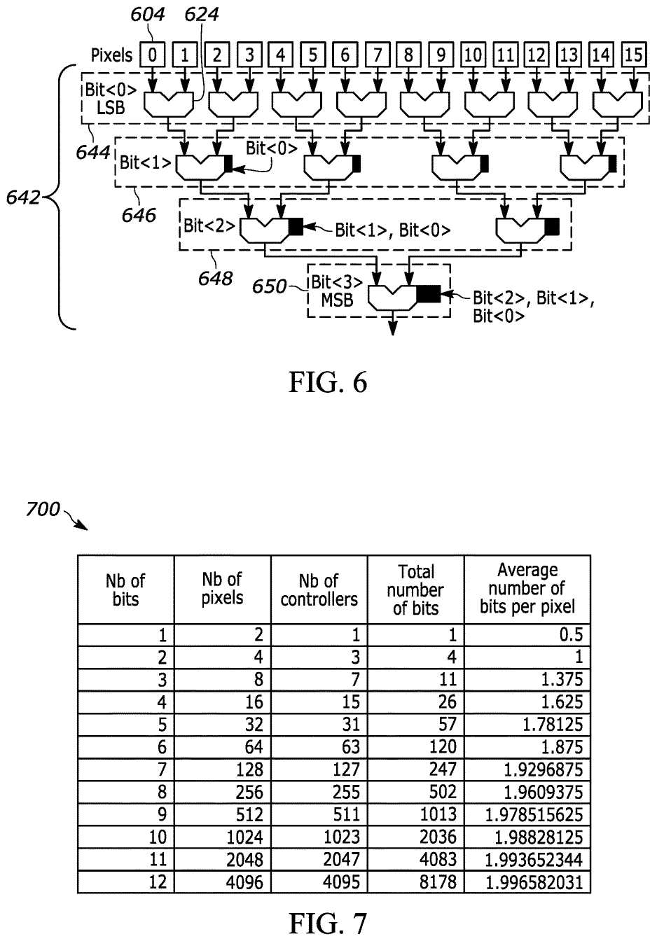

FIG. 6 illustrates a hierarchical tree structure 642 such as the hierarchical tree structure described with reference to FIGS. 3 through 5, with emphasis on address bit generation at each layer of the hierarchical tree structure. In particular, FIG. 6 depicts pixels 604 and controllers (represented as arbiters 624) along with the bit significance of address bits generated by pixel-specific controllers at different layers within the hierarchical tree structure.

The hierarchical tree structure includes four layers, with each layer designated according to the bit significance of the address bit generated by pixel-specific controllers at that layer. A lowest layer 644 is designated as Bit<0> and corresponds to the least significant bit (LSB). Progressively higher layers 646, 648, and 650 are designated as Bit<1>, Bit<2>, and Bit<3>, with Bit<3>, respectively, corresponding to the most significant bit (MSB).

At the Bit<0> layer 644, each pixel-specific controller receives inputs from two adjacent pixel cells and generates the least significant address bit. The pixel-specific controllers at the Bit<0> layer are connected to all sixteen pixel cells as indicated by downward-pointing arrows in FIG. 6, which indicate the flow of request signals and data signals from the pixel cells into the corresponding pixel-specific controllers.

The Bit<1> layer 646 includes pixel-specific controllers that receive inputs from pairs of pixel-specific controllers at the Bit<0> layer. Each pixel-specific controller at the Bit<1> layer generates a next address bit while also passing through the Bit<0> information received from the preceding layer.

The Bit<2> layer 648 similarly includes pixel-specific controllers that receive inputs from pixel-specific controllers at the Bit<1> layer. Each pixel-specific controller at the Bit<2> layer generates an address bit while passing through Bit<1> and Bit<0> data received from preceding layers.

The Bit<3> layer 650 represents a final controller stage nearest the serializer interface. The pixel-specific controller at the Bit<3> layer generates the most significant bit and aggregates Bit<2>, Bit<1>, and Bit<0> information from preceding layers.

As described above, generating the address bit comprises generating a lower-significance address bit by pixel-specific controllers at lower layers of the hierarchical tree structure and generating a higher-significance address bit by pixel-specific controllers at higher layers of the hierarchical tree structure. Each pixel-specific controller contributes one bit of address information based on a position of the pixel-specific controller within the hierarchical tree structure. The event address is therefore naturally encoded by the distributed controller grid as event requests propagate through successive controller layers toward the serializer interface, and the complete address information becomes available at an edge of the array without requiring a separate centralized address encoder.

FIG. 7 depicts a table 700 showing implementation relationships for the distributed controller architecture across varying numbers of bits and pixels. The table contains five columns labeled “Nb of bits,” “Nb of pixels,” “Nb of controllers,” “Total number of bits,” and “Average number of bits per pixel.” The table presents twelve rows of data corresponding to bit counts ranging from one to twelve.

For one bit, the table shows two pixel cells, one pixel-specific controller, one total bit, and an average of 0.5 bits per pixel cell. For two bits, the table shows four pixel cells, three pixel-specific controllers, four total bits, and an average of one bit per pixel cell. For three bits, the table shows eight pixel cells, seven pixel-specific controllers, eleven total bits, and an average of 1.375 bits per pixel cell. For four bits, the table shows sixteen pixel cells, fifteen pixel-specific controllers, twenty-six total bits, and an average of 1.625 bits per pixel cell. For five bits, the table shows thirty-two pixel cells, thirty-one pixel-specific controllers, fifty-seven total bits, and an average of 1.78125 bits per pixel cell.

For six bits, the table shows sixty-four pixel cells, sixty-three pixel-specific controllers, one hundred twenty total bits, and an average of 1.875 bits per pixel cell. For seven bits, the table shows one hundred twenty-eight pixel cells, one hundred twenty-seven pixel-specific controllers, two hundred forty-seven total bits, and an average of 1.9296875 bits per pixel cell. For eight bits, the table shows two hundred fifty-six pixel cells, two hundred fifty-five pixel-specific controllers, five hundred two total bits, and an average of 1.9609375 bits per pixel cell.

For nine bits, the table shows five hundred twelve pixel cells, five hundred eleven pixel-specific controllers, one thousand thirteen total bits, and an average of 1.978515625 bits per pixel cell. For ten bits, the table shows one thousand twenty-four pixel cells, one thousand twenty-three pixel-specific controllers, two thousand thirty-six total bits, and an average of 1.98828125 bits per pixel cell. For eleven bits, the table shows two thousand forty-eight pixel cells, two thousand forty-seven pixel-specific controllers, four thousand eighty-three total bits, and an average of 1.993652344 bits per pixel cell. For twelve bits, the table shows four thousand ninety-six pixel cells, four thousand ninety-five pixel-specific controllers, eight thousand one hundred seventy-eight total bits, and an average of 1.996582031 bits per pixel cell.

The data in FIG. 7 demonstrates that a number of pixel-specific controllers in the array of pixel cells is equal to a number of pixel cells minus one. For example, an array with sixteen pixel cells includes fifteen pixel-specific controllers, an array with two hundred fifty-six pixel cells includes two hundred fifty-five pixel-specific controllers, and an array with four thousand ninety-six pixel cells includes four thousand ninety-five pixel-specific controllers. The relationship N_{controllers}=Nₚᵢₓₑₗₛ−1 holds across all configurations shown in FIG. 7.

The total number of bits represents the aggregate number of address bits generated across all pixel-specific controllers within the hierarchical tree structure. As the number of pixel cells increases, the total number of bits increases in a manner related to the hierarchical tree structure depth and the number of pixel-specific controllers at each layer. For a configuration with n bits, the number of pixel cells is 2ⁿ, and the number of pixel-specific controllers is 2ⁿ−1.

The average number of bits per pixel cell remains less than two across all configurations shown in FIG. 7. As the number of bits increases from one to twelve, the average number of bits per pixel cell increases from 0.5 toward a value approaching but remaining below two. The average number of bits per pixel cell for a twelve-bit configuration is 1.996582031, which demonstrates that the distributed controller architecture maintains an average address bit overhead of less than two bits per pixel cell even for large array sizes. The scaling behavior shown in FIG. 7 indicates that the architecture may scale by replication of local controller elements without requiring a correspondingly complex peripheral control block as array sizes increase.

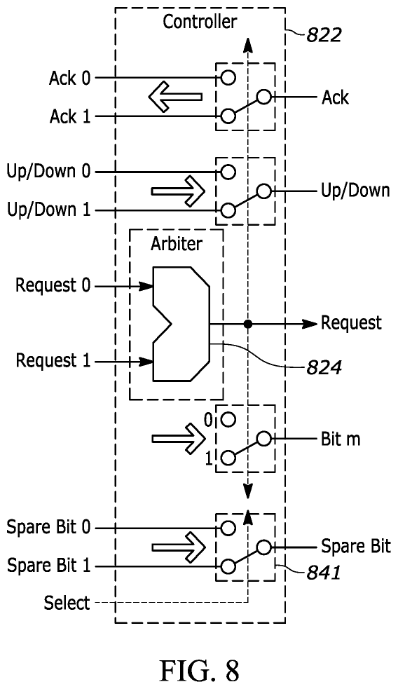

FIG. 8 depicts an example of a pixel-specific controller 822 for use within the distributed arbiter architecture of an event-based sensing system. The pixel-specific controller depicted in FIG. 8 differs from the pixel-specific controller 222 depicted in FIG. 2C in that the pixel-specific controller of FIG. 8 includes a spare address bit output. The spare address bit output enables a universal controller design to be used across all pixel cells in the array, allowing higher-layer address propagation to be handled through configurable routing rather than requiring layer-specific controller variants. The pixel-specific controller depicted in FIG. 8 represents a universal controller design that may be included in each pixel cell of the array. In some arrangements, each pixel-specific controller includes the universal controller design, which enables repeated layout, local regularity, and compatibility with automated place and route based implementation.

As shown in the example of FIG. 8, each pixel-specific controller may further include a spare address bit output configurable through routing. In the arrangement depicted in FIG. 8, the pixel-specific controller includes provisions for a Spare Bit output. Two spare bit inputs, designated as Spare Bit 0 and Spare Bit 1, connect to a selection circuit 841 controlled by a Select signal. The spare address bit output enables additional address routing flexibility through configurable wiring handled by place and route tools. The spare address bit arrangement enables the universal controller design to be included in each pixel cell even when higher-layer address propagation would otherwise require layer-specific controller variants. By adding the spare address bit output, two address bits per pixel-specific controller may be available, which allows the same universal controller design to be used across all pixel cells in the array. The spare-bit selection may be handled through routing and control inputs, with the spare address bit handled by place and route tooling during physical design implementation.

The pixel-specific controller depicted in FIG. 8 operates asynchronously, with the arbiter 824 implementing a first-come-first-served priority scheme. When a request signal arrives at one of the two inputs, the arbiter sets internal switches to route the corresponding Up/Down signal forward toward the serializer interface, direct the acknowledgment signal backward to the appropriate source through the established path, and generate the appropriate address bit value at the Bit m output.

As described above, for each pixel cell, the pixel-specific controller 822 is physically located within the pixel cell adjacent to the pixel-specific photosensor. The pixel-specific photosensor and the pixel-specific controller are fabricated as a unit within each pixel cell, with conductive paths conducting electrical signals from the pixel-specific photosensor to the arbiter of the pixel-specific controller. The physical co-location of the pixel-specific controller and the pixel-specific photosensor within each pixel cell enables distributed arbitration and address generation without requiring complex peripheral arbitration circuitry.

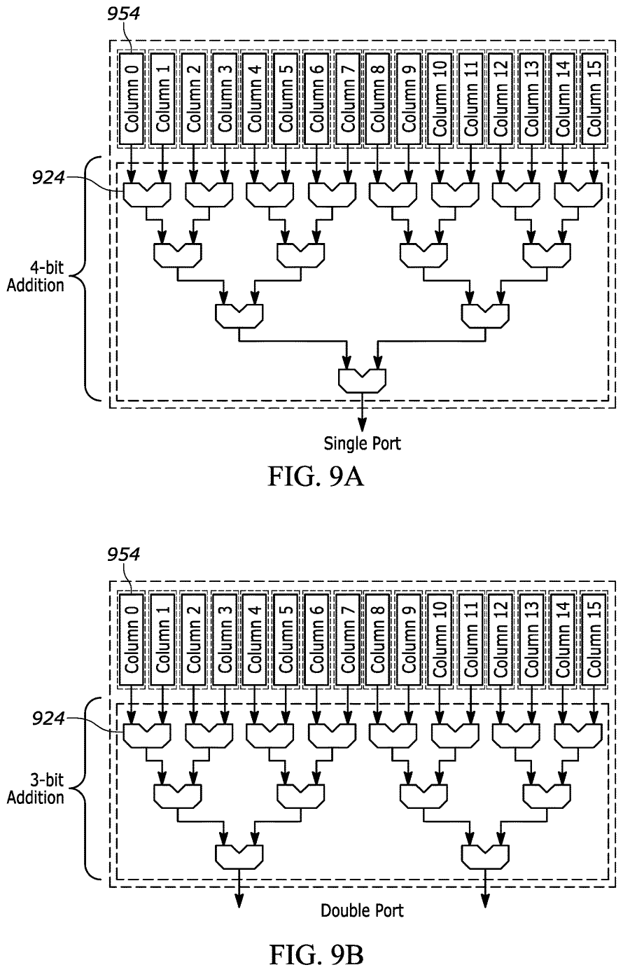

FIG. 9A illustrates a floorplan diagram of a modular slice arrangement for a single-port configuration in the event-based distributed controller architecture. The modular slice arrangement depicted in FIG. 9A comprises a building block including sixteen columns 952, labeled Column 0 through Column 15. Each column represents a portion of the pixel array that feeds into a distributed controller tree network represented as arbiters 924.

In some arrangements, at a target pixel size, one output port per column may be impractical for real-estate and power-consumption reasons. The design may accommodate pad-row constraints that include at least two pads for scalable low-voltage signaling (SLVS) interfacing together with power pads. The modular slice arrangement addresses these floor planning considerations by aggregating event information from multiple columns through the hierarchical tree structure.

The modular slice depicted in FIG. 9A includes a hierarchical tree structure identified within a dashed boundary. The hierarchical tree structure comprises 4-bit addition circuitry that extends a tree output for the single-port arrangement. Within the hierarchical tree structure, multiple layers of pixel-specific controllers are arranged in a converging pattern. The pixel-specific controllers at each layer receive inputs from two sources, either from pixel cells at a first layer or from pixel-specific controllers of a previous layer at higher layers. The hierarchical tree structure progressively combines and arbitrates event information from the sixteen columns, with each successive layer reducing a number of parallel paths by half.

The hierarchical tree structure converges toward a single port. The integrated circuit device may further comprise a serializer coupled to an output of each hierarchical tree structure. The serializer is configured to receive event data and address information from a final layer of the hierarchical tree structure. In the single-port arrangement depicted in FIG. 9A, the 4-bit addition provides additional address bits to identify which of the sixteen columns generated an event, supplementing address bits generated within each column's internal tree structure.

The modular slice arrangement depicted in FIG. 9A is designed to be self-consistent and butt-able. Multiple modular slices may be placed adjacent to one another to form larger pixel arrays. The butt-able design allows the same distributed arbitration concept to be adapted to varying array sizes while maintaining consistent interconnect topology at slice boundaries.

FIG. 9B illustrates a floorplan diagram of a double-port arrangement for a modular slice of the event-based distributed controller architecture. The modular slice depicted in FIG. 9B comprises a building block including sixteen columns 954, labeled Column 0 through Column 15, arranged in a self-consistent sub-pixel array configuration. Each column includes a pixel-specific controller (represented as arbiters 924), with the pixel-specific controllers interconnected through a hierarchical tree structure that extends through multiple layers.

In the double-port arrangement depicted in FIG. 9B, the hierarchical tree structure implements 3-bit addition for address extension. The double-port designation indicates that two tree outputs are provided, each extended with 3 additional address bits to accommodate pad-row constraints and serializer interface requirements. The interconnections between pixel-specific controllers form a binary tree pattern, where pairs of pixel-specific controllers at lower levels connect to pixel-specific controllers at higher levels, enabling distributed arbitration and address generation across the column array.

The modular slice depicted in FIG. 9B is designed to be butt-able, allowing multiple modular slices to be combined to form larger pixel arrays while maintaining consistent interconnect topology. The double-port arrangement may be selected when pad-row constraints or serializer throughput considerations favor two output ports over a single output port.

In operation, a serializer (not shown) coupled to an output of the hierarchical tree structure receives event data and address information from a final layer of the hierarchical tree structure. The serializer serializes the event data and address information for output. The 4-bit addition in the single-port arrangement of FIG. 9A and the 3-bit addition in the double-port arrangement of FIG. 9B provide the additional address bits to identify which column within the modular slice generated an event.

The modular slice arrangements depicted in FIGS. 9A and 9B address floor planning considerations related to pad-row constraints and serializer interface requirements. At smaller pixel sizes, providing one output port per column may be impractical due to real-estate limitations and power-consumption considerations. The modular slice arrangements aggregate event information from sixteen columns through the hierarchical tree structure, reducing a number of output ports while maintaining the distributed arbitration and address generation capabilities of the architecture. The self-consistent and butt-able design of the modular slices enables the architecture to be scaled to varying array sizes by combining multiple modular slices.

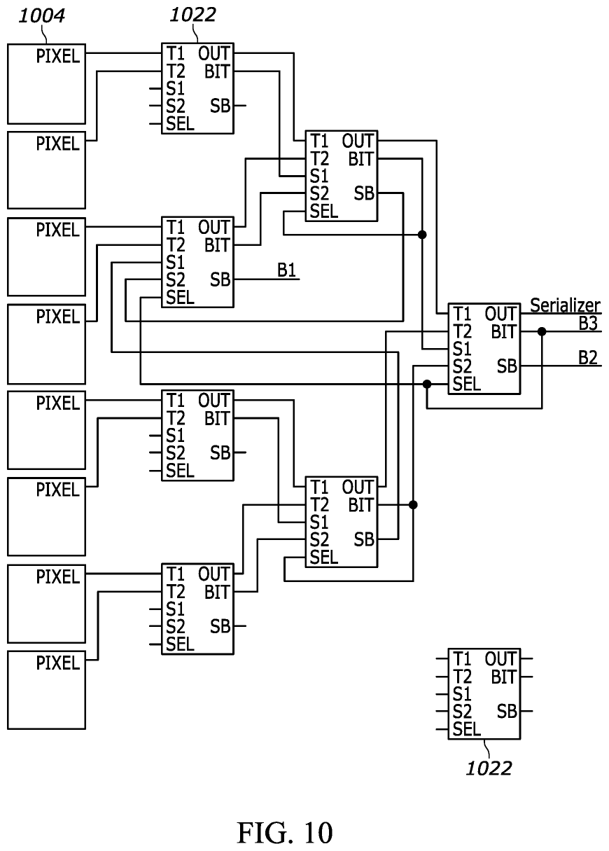

FIG. 10 illustrates a system diagram of a distributed controller arrangement for an event-based pixel array architecture that includes photosensors (e.g., pixels 1004) and controllers 1022. FIG. 10 depicts a logical representation of the controller arrangement and does not represent the physical layout of the pixels and corresponding controllers within the integrated circuit device. In the physical layout, each pixel cell includes a pixel-specific photosensor and a corresponding pixel-specific controller that are fabricated as a unit within the pixel cell. In the arrangement depicted in FIG. 10, multiple pixels are arranged in a column, with each pixel connected to a corresponding controller. Each controller includes multiple input terminals and output terminals. The input terminals include terminals labeled T1, T2, S1, S1, and SEL. The output terminals include terminals labeled OUT BIT and SB. The T1 terminal of each controller receives an input from the corresponding pixel element.

The controllers 1022 are interconnected in a hierarchical tree structure, where an output of one controller feeds into an input of another controller at a subsequent layer. The interconnections between controllers demonstrate bidirectional signal routing capability, with request signals and data signals propagating in one direction and acknowledge signals propagating in a reverse direction. At a right side of the diagram in FIG. 10, a controller has an output to a serializer (not shown). Connections labeled B3 and B2 indicate address bit outputs from the controller. The SB terminals on each controller represent spare bit outputs that may be utilized for address generation. The arrangement depicted in FIG. 10 illustrates how the distributed controller network processes event information from multiple pixel elements simultaneously. Each controller generates address bits based on a position of the controller within the hierarchical tree structure. The serializer receives processed event data and address information at an output of the hierarchical tree structure.

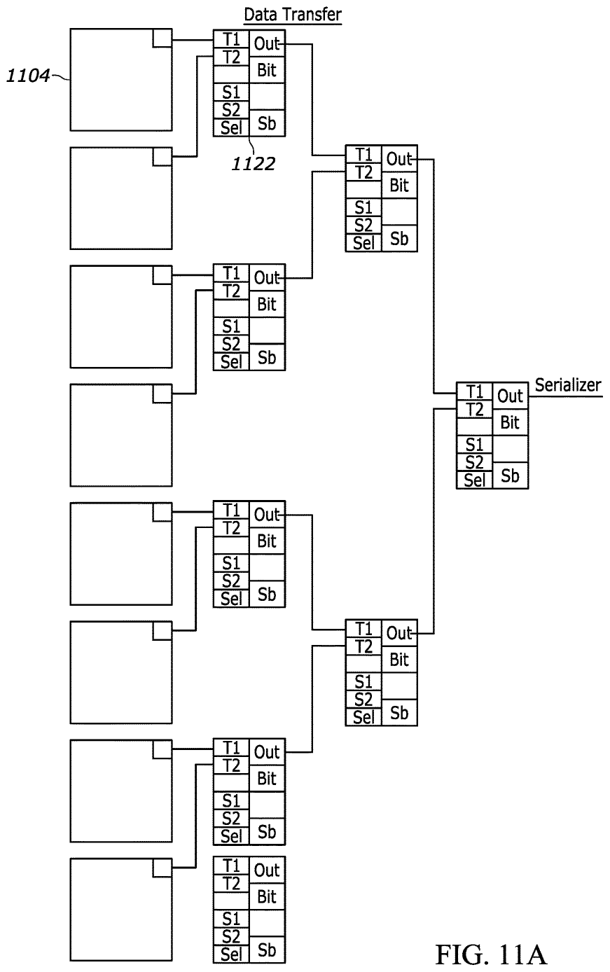

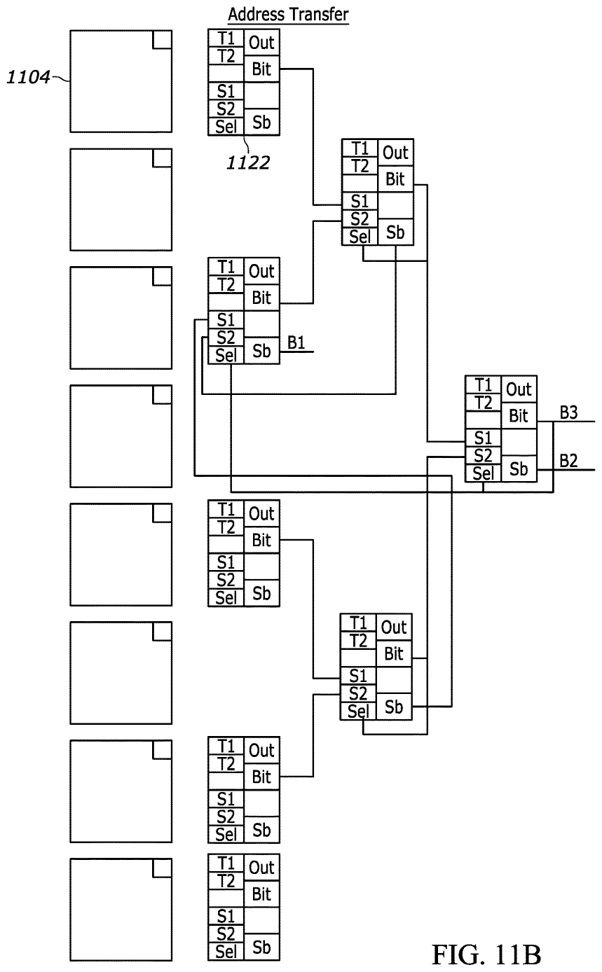

FIG. 11A illustrates a data transfer diagram for the distributed controller architecture within an event-based sensing system as described with reference to FIG. 10 and FIG. 11B illustrates an address transfer diagram for the distributed controller architecture within the event-based sensing system as described with reference to FIG. 10. FIG. 11A depicts the data transfer configuration showing how event data propagates from multiple pixels 1104 through the cascading arrangement of controllers 1122 toward the serializer, with the hierarchical tree structure enabling parallel event information to converge at a common output point while FIG. 11B depicts the corresponding address transfer configuration, illustrating how address bits are generated at each layer of the hierarchical tree structure and routed toward the serializer output to identify the originating pixel cell. The address transfer mechanism depicted in FIG. 11B indicates that address information becomes available at an edge of the array through the distributed controller network without requiring a separate centralized address encoder. The hierarchical tree structure naturally encodes an event address as signals traverse from a pixel level through intermediate controller layers to a final output stage. The address transfer mechanism operates in conjunction with the data transfer path depicted in FIG. 11A to provide complete event information at the serializer interface.

The disclosed architecture may be implemented in a sensor device that is fabricated partially or fully as an integrated circuit device. In some implementations, the integrated circuit device may be fabricated using complementary metal-oxide-semiconductor (CMOS) technology, which enables the pixel-specific photosensors and the pixel-specific controllers to be fabricated on a common semiconductor substrate. CMOS fabrication processes allow the active pixel sensors, arbiters, switching elements, and conductive interconnections of the hierarchical tree structure to be integrated within a monolithic device. The architecture may be implemented at various pixel sizes, and in some arrangements, the pixel cells may have a target pixel size of approximately 10 micrometers. At this target pixel size, the integration of the pixel-specific controller within each pixel cell alongside the pixel-specific photosensor enables distributed arbitration and address generation while maintaining compatibility with the area constraints associated with smaller pixel dimensions. The modular slice arrangements described with reference to FIGS. 9A and 9B address floor planning considerations that arise at the target pixel size, where providing one output port per column may be impractical due to real-estate limitations.

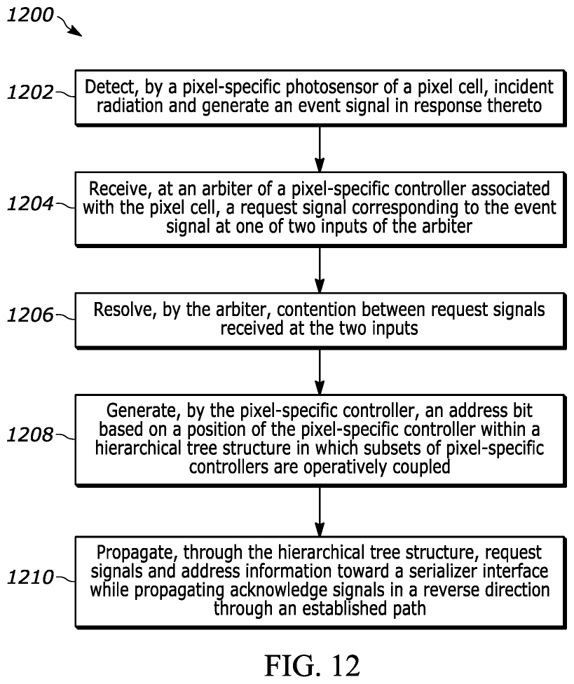

FIG. 12 illustrates a flowchart of a method 1200 of operating an integrated circuit device comprising an array of pixel cells. At step 1202, a pixel-specific photosensor of a pixel cell detects incident radiation and generates an event signal in response thereto. At step 1204, an arbiter of a pixel-specific controller associated with the pixel cell receives a request signal corresponding to the event signal at one of two inputs of the arbiter. At step 1206, the arbiter resolves contention between request signals received at the two inputs. At step 1208, the pixel-specific controller generates an address bit based on a position of the pixel-specific controller within a hierarchical tree structure in which subsets of pixel-specific controllers are operatively coupled. At step 1210, request signals and address information are propagated through the hierarchical tree structure toward a serializer interface while acknowledge signals are propagated in a reverse direction through an established path.

As used herein, the term “event signal” may refer to an electrical signal generated by a pixel-specific photosensor in response to a detected change in incident radiation at the pixel cell location. An event signal may be generated when a change in light intensity at the pixel-specific photosensor exceeds a threshold value, when a transition in illumination occurs, or when other photosensitive detection criteria are satisfied. The event signal initiates a request for communication through the hierarchical tree structure and triggers the arbitration and address generation processes performed by the pixel-specific controllers.

As used herein, the term “operatively coupled” may refer to elements that are connected through conductive interconnections that enable electrical signal communication between the elements. Pixel-specific controllers that are operatively coupled in a hierarchical tree structure are connected through conductive paths, such as metal traces or other conductive elements fabricated within the integrated circuit device, that conduct electrical signals between the arbiter outputs and arbiter inputs of the pixel-specific controllers. As used herein, the term “serializer interface” may refer to a serializer or a connection point at which the hierarchical tree structure delivers event data and address information to a serializer for serialization and output. As used herein, the term “universal controller design” may refer to a controller design that is common across all pixel cells regardless of a layer position of the pixel-specific controller within the hierarchical tree structure. A universal controller design may include a spare address bit output that enables higher-layer address propagation to be handled through configurable routing rather than requiring layer-specific controller variants. As used herein, the term “established path” may refer to a signal path within the hierarchical tree structure that is set by a state of the arbiter when the arbiter resolves contention between request signals. The established path provides a return route through which acknowledge signals propagate from the serializer interface back toward an originating pixel cell.

A number of implementations have been described. Nevertheless, it will be understood that various modifications may be made without departing from the spirit and scope of the disclosure. Accordingly, other implementations are within the scope of the following claims.

What is claim is:

1. An integrated circuit device, comprising:
an array of pixel cells arranged in rows and columns, each pixel cell comprising:
a pixel-specific photosensor configured to generate an event signal in response to detected incident radiation, and
a pixel-specific controller comprising an arbiter having two inputs and one output, the arbiter configured to resolve contention between request signals received at the two inputs,
wherein subsets of the pixel-specific controllers are operatively coupled in respective hierarchical tree structures,
wherein each pixel-specific controller is configured to generate an address bit based on a position of the pixel-specific controller within a respective hierarchical tree structure, and
wherein each hierarchical tree structure is configured to propagate request signals and address information toward a serializer interface while propagating acknowledge signals in a reverse direction through an established path.

2. The integrated circuit device of claim 1, wherein the arbiter comprises an asynchronous latch.

3. The integrated circuit device of claim 2, wherein the asynchronous latch comprises a Set/Reset latch.

4. The integrated circuit device of claim 1, wherein the pixel-specific controllers are operatively coupled in the respective hierarchical tree structures via conductive interconnections coupling the output of an arbiter of one pixel-specific controller to an input of an arbiter of another pixel-specific controller.

5. The integrated circuit device of claim 4, wherein a first layer of each hierarchical tree structure comprises conductive interconnections coupling outputs of arbiters of pixel-specific controllers associated with pairs of adjacent pixel cells to inputs of arbiters of pixel-specific controllers at a second layer, and wherein higher layers of each hierarchical tree structure comprise conductive interconnections coupling outputs of arbiters of pixel-specific controllers from a preceding layer to inputs of arbiters of pixel-specific controllers at a subsequent layer.

6. The integrated circuit device of claim 1, wherein each pixel-specific controller is further configured to store lower-priority event data when a collision occurs between simultaneous request signals from the two inputs.

7. The integrated circuit device of claim 6, wherein each hierarchical tree structure is configured to release the stored lower-priority event data upon receipt of an acknowledge signal.

8. The integrated circuit device of claim 1, wherein a number of pixel-specific controllers in the array of pixel cells is equal to a number of pixel cells minus one.

9. The integrated circuit device of claim 1, wherein each pixel-specific controller comprises a universal controller design, and wherein each pixel-specific controller further comprises a spare address bit output configurable through routing.

10. The integrated circuit device of claim 1, wherein each hierarchical tree structure comprises a plurality of layers, and wherein pixel-specific controllers at lower layers generate lower-significance address bits and pixel-specific controllers at higher layers generate higher-significance address bits.

11. The integrated circuit device of claim 1, further comprising a serializer coupled to an output of each hierarchical tree structure, wherein the serializer is configured to receive event data and address information from a final layer of the hierarchical tree structure.

12. The integrated circuit device of claim 1, wherein, for each pixel cell, the pixel-specific controller is physically located within the pixel cell adjacent to the pixel-specific photosensor.

13. The integrated circuit device of claim 12, wherein each pixel cell comprises a common pixel cell layout, and wherein the pixel-specific photosensor and the pixel-specific controller are integrated within the common pixel cell layout.

14. The integrated circuit device of claim 1, wherein each hierarchical tree structure couples pixel-specific controllers along a column of the array, along a row of the array, or across a plurality of columns or rows of the array.

15. The integrated circuit device of claim 1, wherein: the arbiter of each pixel-specific controller comprises an asynchronous Set/Reset latch, the pixel-specific controllers are operatively coupled in the respective hierarchical tree structures via conductive interconnections, each hierarchical tree structure comprises a plurality of layers wherein pixel-specific controllers at lower layers generate lower-significance address bits and pixel-specific controllers at higher layers generate higher-significance address bits, each pixel-specific controller is configured to store lower-priority event data when a collision occurs between simultaneous request signals from the two inputs and to release the stored lower-priority event data upon receipt of an acknowledge signal, and for each pixel cell, the pixel-specific controller is physically located within the pixel cell adjacent to the pixel-specific photosensor.

16. The integrated circuit device of claim 1, wherein: the arbiter of each pixel-specific controller comprises an asynchronous Set/Reset latch, and the pixel-specific controllers are operatively coupled in the respective hierarchical tree structures via conductive interconnections coupling the output of an arbiter of one pixel-specific controller to an input of an arbiter of another pixel-specific controller, wherein a first layer of each hierarchical tree structure comprises conductive interconnections coupling outputs of arbiters of pixel-specific controllers associated with pairs of adjacent pixel cells to inputs of arbiters of pixel-specific controllers at a second layer, and wherein higher layers of each hierarchical tree structure comprise conductive interconnections coupling outputs of arbiters of pixel-specific controllers from a preceding layer to inputs of arbiters of pixel-specific controllers at a subsequent layer.

17. A method of operating an integrated circuit device comprising an array of pixel cells, the method comprising:
detecting, by a pixel-specific photosensor of a pixel cell, incident radiation and generating an event signal in response thereto;
receiving, at an arbiter of a pixel-specific controller associated with the pixel cell, a request signal corresponding to the event signal at one of two inputs of the arbiter;
resolving, by the arbiter, contention between request signals received at the two inputs;
generating, by the pixel-specific controller, an address bit based on a position of the pixel-specific controller within a hierarchical tree structure in which subsets of pixel-specific controllers are operatively coupled; and
propagating, through the hierarchical tree structure, request signals and address information toward a serializer interface while propagating acknowledge signals in a reverse direction through an established path.

18. The method of claim 17, further comprising:
storing, by the pixel-specific controller, lower-priority event data when a collision occurs between simultaneous request signals at the two inputs of the arbiter; and
releasing the stored lower-priority event data upon receipt of an acknowledge signal.

19. The method of claim 17, wherein generating the address bit comprises generating a lower-significance address bit by pixel-specific controllers at lower layers of the hierarchical tree structure and generating a higher-significance address bit by pixel-specific controllers at higher layers of the hierarchical tree structure.

20. The method of claim 17, further comprising:
receiving, at a serializer coupled to an output of the hierarchical tree structure, event data and address information from a final layer of the hierarchical tree structure; and
serializing the event data and address information for output.
